(19) United States
(12) Patent Application Publication
(10) Pub. No.: US 2019/0076907 A1
(43) Pub. Date: Mar. 14, 2019

(54) STRUCTURE OF CUTTING EDGE OF MACHINING TOOL, AND SURFACE TREATMENT METHOD FOR SAME

(71) Applicant: FUJI MANUFACTURING CO., LTD., Tokyo (JP)

(72) Inventors: Keiji MASE, Tokyo (JP); Shozo ISHIBASH, Tokyo (JP); Yusuke KONDO, Tokyo (JP)

(21) Appl. No.: 16/084,331

(22) PCT Filed: Feb. 21, 2017
(86) PCT No.: PCT/JP2017/006372

§ 371 Date: Sep. 12, 2018

(30) Foreign Application Priority Data
Mar. 31, 2016 (JP) 2016-072429

(51) Int. Cl. B21D 37/20; B23B 27/10; B23B 27/14; B23B 51/06; B23C 5/20; B23C 5/28; B23D 43/00; B23F 21/16; B23P 9/00; B23P 15/28; B24C 1/02

(52) U.S. Cl. CPC B21D 37/20; B23B 27/10; B23B 27/14; B23B 51/06; B23C 5/20; B24C 11/00; B23D 43/00; B23F 21/16; B23P 9/00; B23P 15/28; B24C 1/02; B23C 5/28

(57) ABSTRACT

A cutting edge of a machining tool and a surface treatment method for the same. A cutting edge of a machining tool and a region in the vicinity of the cutting edge, e.g. a region of at least 1 mm and preferably at least 5 mm from the cutting edge, are defined as a treatment region; and substantially spherical injection granules having a median diameter of 1 to 20 μm are injected onto the treatment region with an injection pressure of 0.01 MPa to 0.7 MPa in order for dimples having an equivalent diameter of 1 to 18 μm and preferably 1 to 12 μm, and a depth at least equal to 0.02 μm and at most equal to 1.0 μm to be formed such that the projected surface area of the dimples is at least equal to 30% of the surface area of the treatment region.

### TECHNICAL FIELD

The present invention relates to a structure of a cutting edge portion of a machining tool and a method for surface treatment of the machining tool, and more particularly, to a structure of a cutting edge portion of a machining tool which is provided with a tool edge or a cutting edge (edge) for cutting or cut-through, such as a cutting tool including a drill, an end mill, a hob, a broach, a milling cutter, or a blanking tool including a punch, and a method of treating the surface of the machining tool.

### BACKGROUND OF THE INVENTION

Among the aforementioned machining tools, a cutting tool will be described as an example. In the cutting, as shown in FIG. 1, the surface of a workpiece 20 is physically cut and split by a cutting edge 11 of a cutting tool 10 to scrape part of the workpiece 20. Then, the cutting is carried out by continuously moving forward the cutting edge 11 while removing machining swarf 21 (hereinafter called “swarf”) generated by this scraping.

The ideal cutting is that the cutting edge 11 of the cutting tool 10 enters the surface of the workpiece 20 at a depth at which the workpiece 20 can be cut without unreasonable force. When this ideal cutting is being carried out, pieces of the workpiece discharged as the swarf 21 is scraped with continuous sliding failure by a shear surface 23 extending from the cutting edge 11 of the cutting tool 10 to a surface 22 of the workpiece 20. Then, a so-called “flow type” swarf 21 which slides on a rake face 12 of the cutting tool 10 and is continuously discharged is formed. In such a cutting state, the cutting resistance is also substantially constant, and a finely finished surface 24 with little vibrations and no surface roughness is formed.

In the cutting, due to high pressure, large frictional resistance and cutting heat generated between the swarf 21 and the rake face 12 of the cutting tool 10, part of the swarf 21 is physically and chemically changed to adhere to the front portion of the cutting edge 11. A new cutting edge called a “built-up edge” different from the original cutting edge is formed on the cutting edge 11 of the cutting tool 10 by this adhered swarf. Then, the workpiece 20 is cut by the built-up edge 25 as part of the cutting edge 11 of the cutting tool 10.

Since the built-up edge 25 has high hardness due to work hardening, it is thought that the built-up edge 25 has a function of protecting the original cutting edge 11 of the cutting tool 10.

However, when the built-up edge 25 is generated, since the cutting edge 11 is blunted and the sharpness is impaired, the finished surface 24 becomes rough. Since the tip of the built-up edge 25 is located lower than the original cutting edge 11 of the cutting tool 10, the cut becomes large, thereby decreasing the machining accuracy.

Moreover, since the tip of the built-up edge 25 is located below the original cutting edge 11 as described above, the cutting resistance increases due to an increase in frictional resistance and excessive cutting. As a result, an increase in the cutting temperature and early abrasion of the cutting tool occur, and the built-up edge 25 grows due to adhesion of the swarf and peels off when growing to a certain extent. Since this operation is repeated periodically, generation of the built-up edge 25 makes the machining state with respect to the workpiece 20 unstable, resulting in a rough finished surface 24 of the workpiece 20.

Further, the built-up edge is one of causes of increase in cutting resistance as described above. When the built-up edge sinks into the workpiece and is peeled off in a state where the cutting resistance is large, the falling strength of the built-up edge becomes large and the cutting edge receives very heavy load. A strong load concentrating on the cutting edge causes chipping and/or cutout.

Related art which tackles on the problem concerning the built-up edge 25 formed on the cutting edge 11 of the cutting tool 10 as described above is as follows:
(a) The art directed to hold the built-up edge 25 which was adhered and grown so as not to fall off toward the cutting edge 11 of the cutting tool 10.
(b) The art directed to remove the built-up edge 25 which was adhered before its growth.
(c) The art directed to prevent built-up edge 25 from adhering to the cutting edge 11 of the cutting tool 10.

Among these, as Related art (a) the built-up edge 25 which was adhered and grown is held so as not to fall off with respect to the cutting edge 11 of the cutting tool 10, there is a proposal to provide an oil guide groove on the rake face 12 of the cutting tool 10, and one end of the oil guide groove communicates with the cutting edge 11 and is capable of guiding the cutting oil to the cutting edge 11. The grown built-up edge 25 enters the oil guide groove, whereby the bonding force between the built-up edge 25 and the cutting tool substrate is strengthened due to anchor effect, to thereby prevent the built-up edge 25 from coming off and to have the built-up edge 25 worked as a protective film for the cutting edge 11 of the cutting tool 10 (Patent Document 1).

In addition, as Related art (b) the built-up edge 25 which was adhered is removed before its growth, there are proposals that a cutting method in which when the workpiece 20 is cut by the cutting tool 10, by repeating the slightly reverse rotation of the cutting tool 10 or the workpiece 20 momentarily a plurality of times, the cutting is performed while removing the built-up edge 25 adhering to the cutting edge 11 of the cutting tool 10 during this reverse rotation, (Patent Document 2), or a broaching method in which cutting is performed on the workpiece while applying to either the cutting tool 10 or the workpiece 20 an ultrasonic vibration in substantially the same direction as the cutting direction (Patent Document 3).

Further, as Related art (c) the built-up edge 25 is prevented from adhering to the cutting edge 11 of the cutting tool 10, there is a proposal to cover part of surface or the entire surface layer contact with the workpiece 20 of the cutting tool 10 by a hard coating including 40 to 60% of N and 40 to 60% of Ti in atomic %, and substantially inevitable impurities as the rest thereof (Patent Document 4), or to make the surface roughness of the cutting edge 11 portion as Ra of 0.3 μm or less, and form a TiCN-based coating layer with a thickness of 2 or less on at least the cutting edge 11 (Patent Document 5).

### RELATED ARTS

### Patent Documents

Patent Document 1:

Japanese Unexamined Patent Application Publication No. 2013-146819

Patent Document 2.:

Japanese Unexamined Patent Application Publication No. 2004-268176

Patent Document 3:

Japanese Unexamined Patent Application Publication No.H09-108936

Patent Document 4:

Japanese Unexamined Patent Application Publication No. 2006-255848

Patent Document 5:

Japanese Unexamined. Patent Application Publication No. 2001-277004

### SUMMARY OF THE INVENTION

### Problems to be Solved by the Invention

Regarding the conventional technique introduced as the related art described above, in the invention described in Patent Document 1, there is a proposal to form an oil guide groove on the rake face 12. of the cutting tool 10 to make it difficult for the built-up edge 25 generated on the cutting edge 11 to fall off, thereby promote adhesion of the built-up edge 25 so as to use as a protective film for protecting the original cutting edge 11 of the cutting tool 10.

Here, since the built-up edge 25 generated at the cutting edge 11 of the cutting tool 10 has high hardness as described above, if it is possible to maintain the state where the built-up edge 25 adheres, it can be expected that the built-up edge 25 serves as a protective film.

However, with this method, the cutting edge 11 is blunted due to the formation of the built-up edge 25, and the surface of the workpiece 20 is scraped further deeply with respect to the original cutting position. Accordingly, since the heat generation temperature increases due to the increase in the cutting resistance, it is thought that the abrasion of the flank 13 which is not protected by the built-up edge 25 is accelerated, and eventually the cutting tool 10 is expected to wear away early.

Moreover, in this configuration, since the angle of the cutting edge varies with the growth of the built-up edge 25 and the cutting depth changes, unless measures such as changing the contact angle of the cutting tool 10 with respect to the surface of the workpiece 20 are taken in accordance with the growth of the built-up edge 25, machining cannot he performed in a stable machining state, and the finished surface 24 becomes rough.

Further, according to the method described in Patent Document 1, due to the formation of the oil guide groove, it is difficult for the built-up edge 25 adhering to the rake face 12 to fall off. Therefore, even if it is possible to protect the rake face 12, the maximally grown built-up edge 25 eventually falls off. Therefore, it is impossible to prevent roughness of the finished surface 24 caused by cyclic repetition of adhesion, growth, and falling off with respect to the built-up edge 25 from occurring. In particular, it is thought that the built-up edge 25, which becomes difficult to fall off due to the formation of the oil guide groove, falls off after growing larger. As a result, it is thought that the roughness (irregularities) of the finished surface becomes larger.

In the method described in Patent Documents 2 and 3, by inverting the cutting tool 10 or the workpiece 20 with respect to the cutting direction (Patent document 2), or by applying ultrasonic vibration in the same direction as the cutting direction, the built-up edge 25 adhering to the cutting edge 11 of the cutting tool 10 can be removed before its growth.

However, with this method, the movement of the cutting tool 10 and the workpiece 20 during the cutting becomes complicated, and the device configuration and the operation control of the apparatus become complicated.

In addition, by regularly reversing the rotation or imparting vibration, cutting by continuous sliding failure which is an ideal cutting state does not occur, thus the cutting resistance always fluctuates and the surface of the workpiece is scraped off by shear sliding at constant intervals, accordingly swarf so-called swarf of “shear type” or “plough and tear type” is discharged. As a result, the finished surface 24 is roughened due to the formation of irregularities and tear traces.

Accordingly, in order to obtain a beautiful finished surface 24, it is desirable to prevent the built-up edge 25 itself from adhering to the cutting edge 11 of the cutting tool 10.

As such a configuration, in the above Patent Documents 4 and 5, there is a proposal to form a ceramic-based coating layer of ceramic such as TiN, TiCN or the like on the cutting edge 11 portion of the cutting tool 10.

As described above, in the configuration in which the ceramic-based coating layer is provided, adhesion of the built-up edge 25 hardly occurs due to the presence of the coating layer. Furthermore, since the ceramic-based coating layer has high hardness, therefore the ceramic-based coating layer can be expected as a protective film for suppressing abrasion of the cutting edge 11.

However, even if such coating layer is provided, adhesion of the built-up edge 25 cannot be completely prevented. Moreover, once the coating layer is peeled off, the effect of the built-up edge 25 as the adhesion preventing film and the effect of the cutting edge 11 as the protective film are lost. Thus, surface treatment by this method is also not perfect.

Moreover, since the formation of such a coating layer is generally performed by “physical vapor deposition (PVD)” typified by sputtering or ion plating ([0047] of Patent Document 1, [0006] of Patent Document 5), an expensive PVD apparatus is required to form a coating layer and regenerate the peeled coating layer for the cutting tool 10. In addition, in the vacuum chamber under high vacuum, temperature and reaction gas introduction speed, treatment time and the like must be strictly controlled to form a coating layer, accordingly, a large cost is required for forming the coating layer.

Therefore, there is a great demand for a surface treatment method capable of preventing adhesion of the built-up edge 25 and hardening the surface of the cutting edge 11 portion as in the formation of the coating layer with a simpler method and lower cost.

Here, in Patent Document 1 described above, in order to promote adhesion of the built-up edge 25 and prevent the adhered built-up edge 25 from being peeled off, a configuration in which an oil guide groove is provided on the rake face 12 of the cutting tool 10 is employed.

In Patent Document 5, in order to prevent adhesion of the built-up edge 25, a coating layer is formed after the cutting edge 11 portion of the cutting tool 10 is processed so as to form a smooth surface having surface roughness of Ra of 0.3 μm or less, so that the surface of the coating layer is smoothed.

Adhesion of the built-up edge 25 to the cutting edge 11 portion of the cutting tool 10 is likely to occur when irregularities are formed on the surface of the cutting edge 11 portion of the cutting tool 10, as is apparent from the presence of these conventional techniques (In addition to Patent Document 1, see [0006] of Patent Document 4 in which deterioration of the surface roughness due to abrasion is exemplified as a cause of occurrence of the built-up edge). Then, the generated built-up edge firmly adheres by “anchor effect” (Patent Document 1). in contrast, in the case where the cutting edge 11 portion of the cutting tool 10 is flattened, it is possible to suppress the adhesion of the built-up edge 25, which is understood by those skilled in the technical field of the present invention as the technical common knowledge.

However, as a result of intensive research, the inventors of the present invention has developed means in which by subjecting the cutting edge 11 portion of the cutting tool 10 to a surface treatment for forming irregularities by a predetermined method, frictional resistance of the cutting edge 11 portion of a machining tool such as a cutting tool can be reduced, adhesion of an object to be cut such as the built-up edge 25 can be prevented, and the surface hardness of the part to which surface treatment is applied can be improved.

Even in the state without lubrication or low lubrication, by reducing the friction between the swarf 21 generated during cutting, and the blade face and the rake face, the discharge ability of the swarf 21 is improved.

The ability to reduce the friction can suppress the high temperature of the swarf 21 and the blade face, thus durability can be improved by preventing adhesion.

Moreover, such a surface treatment can be performed by relatively simple processing in which substantially spherical ejection particles are ejected using an inexpensive blasting apparatus in comparison with a method using equipment for physical vapor deposition (PVD), and can be performed simply at low cost in comparison with the process of forming a ceramic-based coating layer or the like

In the above description, the cutting tool is described as an example of a machining tool having a cutting edge. However, the problems explained above are problems not only for cutting tools but also for machining tools in general (hereinafter collectively called “machining tool”) having a cutting edge (edge) which becomes the starting point of shearing at the time of cutting or cutting-through wherein examples of the machining tool include a punches used for punching and the like.

The present invention is made based on the findings obtained as a result of the above research by the inventors of the present invention. It is an object of the present invention to provide a structure of a cutting edge portion of a machining tool and a method of treating the surface thereof, in which adhesion of the built-up edge to the cutting edge portion of the machining tool such as a cutting tool can be prevented, a finished surface without roughness can be formed, and the durability of the machining tool itself can be improved by increasing the surface hardness of the cutting edge portion.

### Means for Solving the Problems

Means for solving the problems are described below with reference numerals used in the detailed description of the preferred embodiments. These reference numerals are intended to clarify the correspondence between the descriptions in the claims and the descriptions in the detailed description of the preferred embodiments, and it is needless to say that these reference numerals should not be used to restrictively interpret the technical scope of the present invention.

In order to achieve the above objective, a method for surface treatment of a cutting edge portion of a machining tool according to the present invention includes:
setting a treatment region 15, the treatment region 15 including the cutting edge (edge) 11 of the machining tool 10 and an area in a vicinity of, preferably in the range of at least 1 mm, more preferably in the range of at least 5 mm from the cutting edge 11;
ejecting substantially spherical ejection particles having a median diameter of 1 to 20 μm to the treatment region 15 at an ejection pressure of 0.01 MPa to 0.7 MPa for forming dimples 16 having an equivalent diameter of 1 to 18 μm, preferably, 1 to 12 μm and a depth of 0.02 to 1.0 μm or less than 1.0 μm so that a projected area of the dimples 16 occupies 30% or more of a surface area of the treatment region 15.

Here, the “median diameter” refers to a particle diameter that when the particle groups are divided into two from a certain particle diameter, a diameter when the integrated particle amount or quantity of a group having large particle and the integrated particle amount of a group having small particle are equal (a diameter of 50 Vol % in a cumulative distribution).

In addition, “equivalent diameter” refers to a diameter of a circle obtained by converting the projected area (in the present specification, “projected area” means the area made by the outer periphery of the dimple 16) of one dimple 16 formed in a treatment region 15 into a circular area, and measuring the diameter of the circular shape.

In the method for surface treatment of a cutting edge portion of a machining tool described above, preferably, preliminarily polishing of the treatment region 15 is performed to a surface roughness of Ra of 3.2 μm or less before the ejection of the ejection particles.

In such case, the preliminary polishing may be performed by ejecting elastic abrasives in which abrasive grains are dispersed in each of an elastic body, or the abrasive grains are carried on each of a surface of the elastic body so that the elastic abrasive are slid on the treatment region 15.

Furthermore, the ejection particles may be ejected on the treatment region 15 to which a ceramic coating such as TiAlN or DLC (Diamond-Like Carbon) has been applied.

When the treatment is applied to a cerarnics-based coating, it is thought that micronization occurs only to the coating layer, thus it is inferred that there is almost no influence on the base material.

Furthermore, a ceramic coating such as TiAlN or DLC (Diamond-Like Carbon) may be applied to the treatment region 15 after the ejection of the. ejection particles.

Moreover, post polishing may be performed to the treatment region 15 for after forming the dimples 16 removing minute protrusions generated at a time of formation of the dimples 16. In such case, the post-polishing may he performed by ejecting elastic abrasives in which abrasive grains are dispersed in each of an elastic body, or the abrasive grains are carried on each of a surface of the elastic body so that the elastic abrasives are slid on the treatment region 15.

Furthermore, a structure of a cutting edge portion of a machining tool according to the present invention includes dimples having an equivalent diameter of 1 to 18 μm, preferably, 1 to 12 μm, and a depth of 0.02 to 1.0 μm or less than 1.0 μm are formed in a treatment region including a cutting edge and an area in a vicinity of, preferably in the range of at least 1 mm, more preferably in the range of at least 5 mm from the cutting edge 11 of the machining tool 10 so that a projected area of the dimples occupies 30% or more of a surface area of the treatment region.

### Effect of the Invention

The following remarkable effects are able to be obtained by using the machining tool subjected to the surface treatment of the cutting edge portion by the surface treatment method of the present invention described above.

Contrary to the common technical knowledge described above, although in a machining tool 10 in which the predetermined range (the treatment region 15) including the cutting edge 11 is treated by the method of the present invention, irregularities are formed on the surface by forming the dimples 16, while generation of the built-up edge 25 can be suppressed.

That is, the above-described dimples 16 are formed in the treatment region 15 treated by the method of treating the cutting edge according to the present invention, and the dimples 16 function as an oil reservoir. Therefore, an oil film of lubricating oil (cutting oil) is formed on the cutting edge 11 and on the rake face 12 and/or the flank 13 located in a certain range from the cutting edge 11. As a result, the frictional resistance between the cutting edge 11 and the rake face 12 in the vicinity of the cutting edge of the machining tool 10 and the swarf 21, and the frictional resistance between the flank 13 and the finished surface 24 are greatly reduced, and large frictional resistance and generation of cutting heat, which are main cause of the swarf 21 being cured and adhered to the rake face 12, is suppressed. As a result, it is thought that generation of the built-up edge 25 can be prevented.

As described above, in the machining tool 10 whose cutting edge 11 portion is treated by the surface treatment method of the present invention, as a result of suppressing generation of the built-up edge 25, problems such as bluntness of the cutting edge 11 which is caused by generation of the built-up edge 25, an increase in the amount of cut and decrease in accuracy accompanying these, an increase in frictional resistance and cutting resistance due to excessive cutting, an increase in cutting temperature, early abrasion of the cutting tool, chipping and/or cutout caused by falling off of the built-up edge 25, occurrence of surface roughness of the finished surface 24 due to change in cutting resistance and the like, all of which are caused by the formation of the built-up edge 25, can be solved.

Further, by forming the dimple 16 by collision of the ejection particles described above, crystal grains in the range of about 3 μm from the surface of the treatment region can be micronized by deformation caused by collision with the ejection particles. As a result of this micronization, it is possible to suppress the occurrence of thermal cracks caused by expansion and contraction due to heat generated at the time of cutting, and the surface hardness can be increased by a relatively simple process.

In addition, compressive residual stress can be imparted to the treatment region by defog on caused by collision of the ejection particles, and the durability of the tool treated by the method of the present invention can be. further improved.

As a result, in the method of treating the cutting edge according to the present invention, the effect of a heat treatment of carburization or nitriding performed to raise the surface hardness, or surface strengthening obtained with ceramic coating typified by TiAlN can be obtained by relatively simple treatment, i.e., an ejection of ejection particles. The method can be employed as an alternative to the heat treatment or ceramic coating.

Although the cutting edge treatment of the present invention is performed on a treatment region in which a tool mark or the like remains, that is, it is possible to perform the treatment on a treatment region in which irregularities remains to some extent, by performing the treatment on the treatment region which has been preliminarily polished to the surface roughness of Ra of 3.2 μm or less, it is possible to process the surface of the cutting edge portion into a more preferable surface state.

In the case where such polishing is performed by ejecting an elastic abrasive, preliminary polishing to a mirror-finished surface or a state close thereto can be carried out comparatively easily by blasting using a blasting apparatus, accordingly it is possible to perform polishing efficiently in comparison with a case of a manual lapping or buffing.

It should be noted that the surface treatment method of the present invention can also be carried out on the above-mentioned treatment region is coated with a ceramic such as TiAlN. In this case, not only the effect associated with the formation of the dimple is obtained, but also improvement in durability of the coating layer due to micronization of the structure of the coating layer can be obtained.

Furthermore, in the configuration in which post-polishing is carried out to remove minute protrusions 17 generated at the time of forming the dimple 16 after the ejection of the ejection particles, not only is it possible to finish the finished surface 24 of the workpiece 20 which had been cut or the like using such a surface-treated machining tool 10 to a more beautiful surface without roughness, it is also possible to further improve the durability of the machining tool 10. In particular, by performing such post-polishing by ejecting an elastic abrasive, it is possible to perform polishing relatively simply and easily.

### BRIEF DESCRIPTION OF DRAWINGS

FIG. 1 is an explanatory view of a cutting tool and a workpiece in a cutting state.

FIG. 2 is an explanatory view of a treatment region to which a surface treatment of the present invention is applied, in which (A) illustrates a state before treatment and (B) illustrates a state after treatment.

FIG. 3 is an explanatory view of protrusions occurring on the surface of the machining tool as a dimple is formed.

FIG. 4 is a surface electron micrograph (SEM image) of a cutting edge portion of a machining tool treated by a surface treatment method of the present invention.

FIG. 5 is a state photograph of the cutting edge portion of the cutting tool, wherein (A) illustrates an untreated state of the cutting edge portion, (B) and (D) illustrate a state of the cutting edge portion treated by the surface treatment method of the present invention, (C) and (E) illustrate a state of the cutting edge portion treated by the method of Comparative Examples.

FIG. 6 illustrates a state of the cutting edge portion of the cutting tool, wherein (A) illustrates a state of the cutting edge portion treated by a method according to an Example and (B) illustrates a state of the cutting edge portion treated by a Comparative Example.

FIG. 7 is a photograph illustrating a state of swarf discharged by machining according to an Example and a Comparative Example.

### DESCRIPTION OF EMBODIMENTS

Embodiments of the present invention will be described below with reference to the attached drawings.

### Object to be Treated

The method of treating the cutting edge according to the present invention is used for processing the cutting edge 11 portion in the machining tool 10 for cutting or cutting-through such as a cutting tool and a blanking tool which has a cutting edge 11 as a starting point of shearing. For example, a punch, a drill, an end mill, a hob, a broach, a milling cutter and the like are included in the machining tool 10 to be processed according to the present invention.

The material of such a machining tool 10 is not particularly limited and may be cemented carbide, or ceramics (alumina, zirconia, silicon carbide, cermet) or the like as well as steel such as SKD (mold tool steel), SK (carbon tool steel), and SKH (high-speed tool steel.)

In the machining tool 10 made of the above material, a ceramics-based layer such as TiAlN, TiC or the like having a thickness of 1 to 10 μm may be formed on the surface of a cutting edge 11 and a portion in the vicinity thereof (a region to be described later or the treatment region 15).

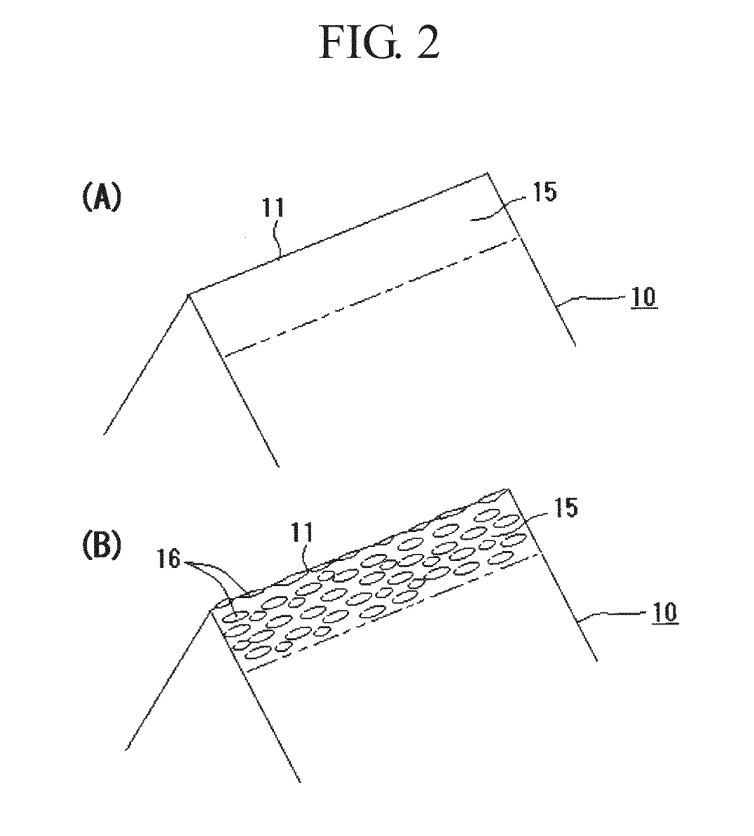

The method of treating the cutting edge according to the present invention is applied to the cutting edge portion of such a machining tool 10. As shown in FIG. 2(A), ejection particles to be described later are ejected and collided with a portion of a cutting edge 11 (edge), which is a starting point of shearing at the time of cutting or cutting-through, and a region 15 as the treatment region 15 in the range of at least 1 mm, preferably in the range of at least 5 mm from the cutting edge 11, thereby dimples 16 are formed in this treatment region 15 as shown in FIG. 2(B).

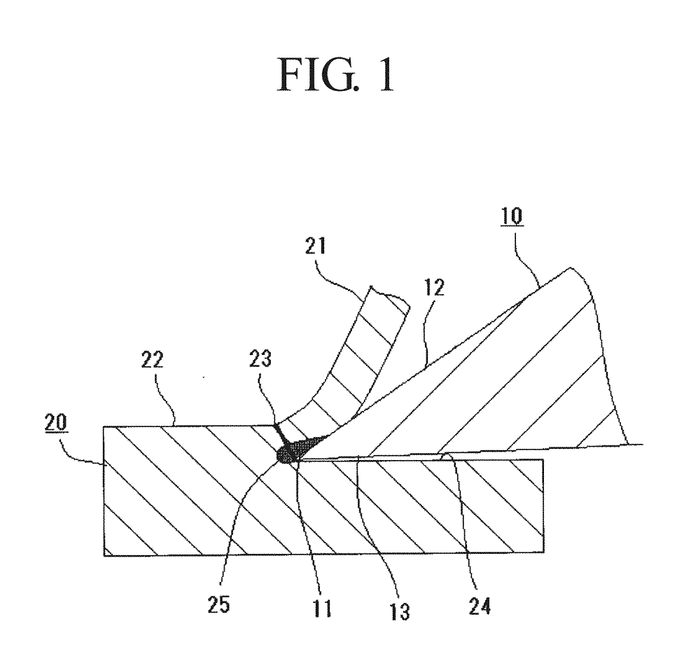

In the present embodiment, both of the inclined surfaces on both sides of the cutting edge 11 are set as the treatment region 15. The treatment region 15 may be one face which receives greater frictional resistance during cutting (the rake face 12 in the example of FIG. 1).

Although the treatment region 15 of the machining tool 10 may be in a state in which a burr is attached to the cutting edge or a state in which a machining mark such as a tool mark is formed, it is preferable to perform preliminary polishing to a surface roughness of 3.2 μm or less at an arithmetic average roughness (Ra).

The method of such preliminary polishing is not particularly limited. Preliminary polishing may be performed by manual lapping or buffing. However, preliminary polishing may be performed by blasting using an elastic abrasive.

Here, the elastic abrasive is an abrasive in which abrasive grains are dispersed in an elastic body such as rubber or elastomer, or abrasive grains are carried on the surface of an elastic body. Such an elastic abrasive can be made to slide on the treatment region 15 by obliquely ejecting the elastic abrasives, for example. As a result, the surface of the treatment region 15 can be polished to a mirror surface state or a state close thereto in a relatively simple manner.

The abrasive grains to be dispersed or carried on the elastic body of the elastic abrasive can be appropriately selected according to the material of the machining tool to be treated and the like. As an example, grains having a particle diameter of # 1000 grit to # 10000 grit made of silicon carbide, alumina, diamond abrasive grains can be used.

### Surface Treatment

The surface treatment of the treatment region 15 located in the predetermined range from the cutting edge 11 of the machining tool 10 is performed by ejecting the substantially spherical ejection particles and making the particles to collide with the treatment region described above.

The ejection particles, an injection device and injection conditions used. for this surface treatment are described below as an example.

### Ejection Particle

“Substantially spherical” in the substantially spherical ejection particles used in the surface treatment method of the present invention does not necessarily means that the ejection particle is strictly a “sphere”. As long as it is a particle of any non-angular shape and which is generally used as “shot”, it is included in the “substantially spherical ejection particle” used in the present invention, even if it is an elliptical shape or a barrel shape, for example.

As the material of the ejection particles, either metallic or ceramics material can be used. Examples of the material of the metallic ejection particle include alloy steel, cast iron, high-speed tool steel (high-speed steel) (SKH), tungsten (W), stainless steel (SUS) and the like. Examples of the material of the ceramic ejection particle include alumina (Al₂O₃), zirconia (ZrO₂), zircon (ZrSiO₄), hard glass, glass, silicon carbide (SiC), and the like. For these ejection particles, it is preferable to use ejection particles of a material having hardness equal to or higher than that of the base material of the machining tool to be treated.

The particle diameter of the ejection particles to be used can be in the range of 1 to 20 μm in median diameter (D₅₀). For iron-based ejection particle, the diameter is 1 to 20 μm in median diameter (D₅₀), preferably 5 to 20 μm. For ceramics-based ejection particle, the diameter is 1 to 20 μm in median diameter (D₅₀), preferably in the range of 4 to 16 μm. From the ejection particles with these particle diameters, ejection particles capable of forming a dimple with a diameter and a depth described later are selected and used according to the material of the machining tool to be treated.

### Ejection Device

A known blasting apparatus that ejects an abrasive together with compressed gas can be used as an ejection device that ejects the aforementioned ejection particles to the surface of the treatment region.

Commercially available blasting apparatuses include a suction type blasting apparatus that ejects abrasives by utilizing a negative pressure generated by the ejection of compressed gas, a gravity type blasting apparatus that ejects an abrasive dropped from an abrasive tank so as to be ridden on compressed gas, a direct pressure type blasting apparatus in which compressed gas is introduced into a tank into which an abrasive is supplied and the abrasive flow from the abrasive tank is combined with the compressed gas flow from a separately provided compressed gas supply source, a blower type blasting apparatus which ejects the compressed gas of the direct pressure type blasting apparatus is ejected onto a gas flow generated by a blower unit and the like. Any of these can be used for ejecting the ejection particles described above.

### Treatment Conditions

The ejection of the ejection particles using the above-mentioned blasting apparatus, can be performed as an example, with the ejection pressure range of 0.01 MPa to 0.7 MPa, preferably, in the range of 0.05 to 0.5 MPa. In view of the material of the machining tool to be treated, the ejection particles are ejected for forming the dimples 16 each having an equivalent diameter of 1 to 18 μm, preferably 1 to 12 μm, and a depth of 0.02 to 1.0 μm or less than 1.0 μm so that the formation area (projected area) of the dimples 16 occupies 30% or more of the area of the surface of the treatment region.

### Post Treatment

As described above, the dimples 16 are formed on the treatment region by the ejection of the ejection particles, and the machining tool 10 which has been subjected to micronization or the like of crystal grains in the vicinity of the surface may be used for machining such as cutting and the like as it is. In this manner, by ejecting and sliding the same elastic abrasives as described in pretreatment on the treatment region 15 after forming the dimples 16, post-polishing may be performed to remove minute protrusions 17 generated at the time of forming the dimples 16.

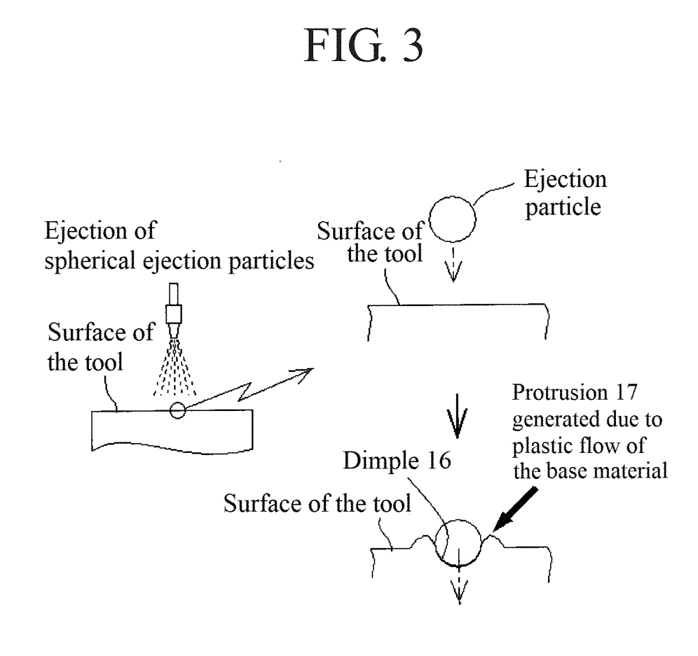

That is, the dimples 16 are formed by causing the above-described ejection particles to collide with the treatment region 15, whereby as shown in FIG. 3, in the treatment region 15, a constituent material pushed out by collision of the ejection particles swells the periphery of the dimple 16 to form the protrusions 17. The protrusions 17 formed in this manner increase the contact resistance when contacting the surface of the workpiece 20 or the swarf 21.

Therefore, it is preferable to remove the minute protrusions 17 generated at the time of formation of the dimples 16 while leaving the dimples 16 by performing the above-described post-polishing by ejecting the elastic abrasives.

Further, a ceramic-based coating layer such as TiAlN, TiC or the like may be formed in the treatment region after ejecting the ejection particles, in some cases, furthermore, in the treatment region after ejecting the elastic abrasives.

The coating layer formed on the treatment region after forming the dimples in this manner is preferably formed with a film thickness of 1 to 10 μm.

Such a coating layer can be formed by using various known film forming techniques such as physical vapor deposition (PVD) typified by sputtering and the like, chemical vapor deposition (CVD) and the like.

### Operations and Effects etc.

As described above, in the surface treatment method of the present invention, the ejection particles of a predetermined diameter are ejected, thereby forming the dimple 16 having a predetermined diameter and a predetermined depth at the cutting edge 11 of the machining tool 10 and in the treatment region 15 located in a certain range from the cutting edge 11 for making the treatment region 15 irregular.

Therefore, as described in the section of the problem to be solved by invention, in light of the common technical knowledge in the technical field of the present invention that a built-up edge 25 is likely to be formed easily on the cutting edge 11 portion where the irregularities are formed on the surface, it can be predicted that the formation of the built-up edge 25 will be promoted in the machining tool 10 whose cutting edge 11 portion is made irregular by forming the dimples 16.

However, when machining (cutting) is carried out using a tool 10 whose cutting edge 11 portion is treated by the treatment method of the present invention, contrary to the predicted results in light of the common technical knowledge, it has been found that adhesion of the workpiece 20 to the cutting edge 11 portion typified by generation of the built-up edge 25 can be prevented.

Probably, the adhesion preventing effect of the workpiece 20 in such a manner can be achieved by the following principle. in the machining tool 10 subjected to the surface treatment on the cutting edge portion by the method of the present invention, a comparatively small dimple 16 corresponding to the particle diameter of the ejection particles is formed in the cutting edge 11 (edge) and a region 15 (treatment region) located in a predetermined range from the cutting edge 11.

Due to the formation of the dimple 16, in the machining tool 10 subjected to the surface treatment of the present invention, the lubricating oil is easily supplied to the cutting edge 11, and the dimple 16 functions as an oil reservoir and holds the lubricating oil, whereby an oil film is formed on the rake face 12 and/or a flank 13 both of which are located within a certain range from the cutting edge 11, it is possible to greatly reduce the frictional resistance at the time of contact between the distal end portion of the machining tool 10 and a swarf 21 and a finished surface 24 of the workpiece 20.

Here, the above-mentioned built-up edge 25 is generated by physically and chemically changing part of the swarf 21 due to the pressure, the large frictional resistance, and the high cutting heat generated between the swarf and the rake face 12 of the tool 10 and adhering to the rake face 12 in the vicinity of the cutting edge 11. However, as described above, by performing the surface treatment of the present invention, it is possible to greatly reduce the contact resistance between the swarf 21 and the rake face 12 by forming the dimples 16 that hold the oil film on the rake face 12. Therefore, when applying the treatment method of the present invention, all the generation conditions of the built-up edge 25 does not exist.

As a result, in the machining tool 10 in which the surface treatment method of the present invention is performed, the built-up edge 25 is difficult to generate. Thus, it is possible to solve problems such as bluntness of the cutting edge 11 caused by generation of the built-up edge 25, a decrease in machining accuracy due to an increase in the amount of cut, and temperature rise at the time of cutting and early abrasion of the cutting tool accompanying an increase in cutting resistance due to friction and excessive cutting.

Further, when the dimples 16 for holding the lubricating oil are also formed on the flank 13 of the tool, the contact between the finished surface 24 and the flank 13 of the workpiece 20 also becomes smooth, whereby it is possible to perform cutting with continuous shearing due to a constant cutting resistance. As a result, occurrence of roughening such as irregularities on the treatment surface can be more suitably prevented.

As described above, continuous shearing with a constant cutting resistance is carried out, which is assured by the fact that in the cutting using the machining tool to which the surface treatment of the cutting edge portion is applied by the surface treatment method of the present invention, the swarf is not a “shear type”, a “plough and tear type”, or a “crack type” but a “flow type” which is generated smoothly and continuously.

Note that in the machining tool 10 which has been subjected to the cutting edge portion treatment by the surface treatment method of the present invention, the crystal grains are micronized in the range of about 3 μm from the surface of the treatment region 15 by the collision of the ejection particles described above. This micronization can suppress occurrence of thermal cracks due to expansion and contraction caused by heat generated at the time of cutting, whereby high durability and long lifespan can be achieved. Particularly, in the case where the machining tool 10 made by SKD11 is treated, the crystal grains in the vicinity of the surface of the treatment region can be micronized to the nano level, whereby further higher durability and longer lifespan can be achieved.

Further, in the machining tool 10 treated by the treatment method of the. present invention, it has been found that not only is the structure near the surface of the treatment region micronized, but also when the residual stress has been measured, a high compressive residual stress is imparted.

The presence of such a compressive residual stress brings about improvement in durability, and due to the above-described micronization and compressive residual stress, the cutting edge treatment of the present invention has been made to have high hardness and high strength, and can replace a heat treatment of carburization or nitriding, or a formation of a ceramic-based hard coating layer.

Such micronization and application of compressive residual stress is similarly obtained when the treatment is performed on a machining tool wherein a ceramic-based coating layer is formed on a treatment region.

Further, as described above, the surface hardness of the treatment region where the ejection particles collided is increased accompanying with the micronization. When a ceramic-based coating layer is formed on this treatment region, as the hardness difference between the base material and the coating layer becomes smaller, the adhesion strength of the coating layer is improved, while dimples corresponding to the surface shape of the base material layer are formed on the surface of the coating layer formed with a substantially uniform film thickness on the base material on which the dimples are formed, whereby it is possible to obtain the effect associated with the formation of dimples as it is.

### EXAMPLES

Hereinafter, the results of the test for validating effects, in which the machining is carried out by using the machining tool subjected to the surface treatment of the cutting edge portion by the surface treatment method of the. present invention, are shown as test examples.

### Test Example 1

### Test for Validating Effects for Cutting Tool Outline of the Test

Cutting tools whose cutting edge portion is treated by the surface treatment method of the present invention (Examples) and cutting tools whose cutting edge portion is not treated and cutting tools treated under treatment conditions deviating from the conditions specified in the present invention (Comparative Examples) are used to perform cutting, and each lifespan is measured by determining that each cutting tool reaches its lifespan when chipping and adhesion of the cutting edge occur.

### Cutting Tool to be Treated

The cutting tools shown in the following Table 1 are used.

TABLE 1
Cutting tool to be tested

| | | Size | |
|---|---|---|---|
| | | Diameter | Blade length |
| Tool type | Material | (mm) | (mm) |
| Straight drill | SKH51 | 10 | 95 |
| Ball end mill | SKH51 | 12 | 36 |
| Bite | Cemented carbide | — | 24 |
| Bite | Alumina | — | 24 |
| Bite | Cermet | — | 24 |
| Tap | SKH57 | 6 | 19 |
| Broach | SKH51 | 9 | 9.5 |
| Flat milling cutter | SKH5l | 100 | — |
| Side milling | SKH57 | 52 | — |
| cutter | | | |
| Hob | SKH57 | 75 | — |
| Reamer | SKH57 | 6 | 47 |
| Metal saw | Cemented carbide | 125 | 2 |

### Surface Treatment Conditions

Surface treatment was carried out under the conditions indicated in the following Tables 2 to 13 with respect to the cutting edge and the range of 5 mm from the cutting edge of each of the above cutting tools.

TABLE 2
Straight chill (SKH51)

| | | | Example | Example | Comparative |
|---|---|---|---|---|---|
| | | | 1 | 2 | Example 1 |
| Surface | Ejection method | | SF | SF | SF |
| treatment | Median diameter | | 13 | 13 | 48 |
| | D₅₀ (μm) | | (alloy | (alloy | (high- |
| | of ejection particle | | steel) | steel) | speed |
| | | | | | steel) |
| | Ejection pressure | | 0.3 | 0.3 | 0.3 |
| | (MPa) | | | | |
| | Nozzle diameter | | 7 | 7 | 7 |
| | (mm) | | | | |
| | Ejection time (sec) | | 5 | 5 | 5 |
| Post- | Ejection method | | — | LD | — |
| polishing | Elastic | Particle | — | 650 | — |
| | abrasive | diameter | | | |
| | | D₅₀ (μm) | | | |
| | | Abrasive | — | # 10000 | — |
| | | grain | | (Diamond) | |
| | | # | | | |
| | | (material) | | | |

| | | | |
|---|---|---|---|
| Ejection pressure | — | 0.05 | — |
| (MPa) | | | |
| Nozzle diameter | — | 9 | — |
| (mm) | | | |
| Ejection time (sec) | — | 10 | — |

TABLE 3
Ball end mill (SKH51)

| | | Example | Example | Example | Comparative |
|---|---|---|---|---|---|
| | | 3 | 4 | 5 | Example 2 |
| Surface | Ejection | SF | FD | LD | LD |
| treatment | method | | | | |
| | Median | 8 | 4 | 20 | 80 |
| | diameter | (Zirconia) | (Alumina) | (Alloy | (Alloy |
| | D₅₀ (μm) of | | | steel) | steel) |
| | ejection | | | | |
| | particle | | | | |
| | Ejection | 0.5 | 0.3 | 0.03 | 0.05 |
| | pressure | | | | |
| | (MPa) | | | | |
| | Nozzle | 7 | 5 | 9 | 9 |
| | diameter | | | | |
| | (mm) | | | | |
| | Ejection | 3 | 3 | 3 | 3 |
| | time (sec) | | | | |

TABLE 4
Bite (carbide)

| | | | | | Compar- |
|---|---|---|---|---|---|
| | | | | | ative |
| | | | Example | Example | Example |
| | | | 6 | 7 | 3 |
| Pre- | Ejection method | | — | SF | — |
| polishing | Elastic | Particle | — | 650 | — |
| | abrasive | diameter | | | |
| | | D₅₀ (μm) | | | |
| | | Abrasive | — | # 10000 | — |
| | | grain # | | (Diamond) | |
| | | (material) | | | |

| | | | | |
|---|---|---|---|---|
| | Ejection pressure | — | 0.3 | — |
| | (MPa) | | | |
| | Nozzle diameter | — | 9 | — |
| | (mm) | | | |
| | Ejection time | — | 15 | — |
| | (sec) | | | |
| Surface | Ejection method | SF | FD | FD |
| treatment | Median diameter | 15 | 7 | 36 |
| | D₅₀ (μm) | (Zirconia) | (Alloy | (High- |
| | of ejection | | steel) | speed |
| | particle | | | steel) |
| | Ejection pressure | 0.3 | 0.3 | 0.3 |
| | (MPa) | | | |
| | Nozzle diameter | 7 | 5 | 5 |
| | (mm) | | | |
| | Ejection time | 3 | 3 | 3 |
| | (sec) | | | |

TABLE 5
Bite (Alumina)

| | | | Comparative |
|---|---|---|---|
| | | Example 8 | Example 4 |
| Surface | Ejection method | SF | SF |
| treatment | Median diameter D₅₀ (μm) of | 20 | 80 |
| | ejection particle | (Zirconia) | (Zirconia) |
| | Ejection pressure (MPa) | 0.6 | 0.5 |
| | Nozzle diameter (mm) | 7 | 7 |
| | Ejection time (sec) | 3 | 3 |

TABLE 6
Bite (Cermet)

| | | | Comparative |
|---|---|---|---|
| | | Example 9 | Example 5 |
| Surface | Ejection method | FD | SF |
| treatment | Median diameter D₅₀ (μm) of | 8 | 63 (Alloy |
| | ejection particle | (Zirconia) | steel) |
| | Ejection pressure (MPa) | 0.5 | 0.5 |
| | Nozzle diameter (mm) | 5 | 7 |
| | Ejection time (sec) | 3 | 3 |

TABLE 7
Tap (SKH57)

| | | | Comparative |
|---|---|---|---|
| | | Example 10 | Example 6 |
| Surface | Ejection method | FD | FD |
| treatment | Median diameter D₅₀ (μm) of | 15 | 63 |
| | ejection particle | (Zircon) | (Zircon) |
| | Ejection pressure (MPa) | 0.1 | 0.1 |
| | Nozzle diameter (mm) | 5 | 5 |
| | Ejection time (sec) | 3 | 3 |

TABLE 8
Broach (SKH51)

| | | Example | Example | Example | Comparative |
|---|---|---|---|---|---|
| | | 11 | 12 | 13 | Example 7 |
| Surface | Ejection | SF | FD | LD | SF |
| treatment | method | | | | |
| | Median | 16 | 15 | 13 | 44 |
| | diameter | (Alumina) | (Zircon) | (Alloy | (Alumina) |
| | D₅₀ (μm) of | | | steel) | |
| | ejection | | | | |
| | particle | | | | |
| | Ejection | 0.1 | 0.3 | 0.05 | 0.1 |
| | pressure | | | | |
| | (MPa) | | | | |
| | Nozzle | 7 | 5 | 9 | 7 |
| | diameter | | | | |
| | (mm) | | | | |
| | Ejection | 5 | 5 | 5 | 5 |
| | time (sec) | | | | |

TABLE 9
Flat milling cutter (SKH51)

| | | | Example | Example | Comparative |
|---|---|---|---|---|---|
| | | | 14 | 15 | Example 8 |
| Pre- | Ejection method | | — | LD | — |
| polishing | Elastic | Particle | — | 650 | — |
| | abrasive | diameter | | | |
| | | D₅₀ (μm) | | | |
| | | Abrasive | — | #3000 | — |
| | | grain # | | (SiC) | |
| | | (material) | | | |

| | | | | |
|---|---|---|---|---|
| | Ejection pressure | — | 0.06 | — |
| | (MPa) | | | |
| | Nozzle diameter | — | 9 | — |
| | (mm) | | | |
| | Ejection time (sec) | — | 15 | — |
| Surface | Ejection method | FD | SF | FD |
| treatment | Median diameter | 7 | 15 | 36 |
| | D₅₀ (μm) | (Alloy | (High- | Alloy |
| | of ejection particle | steel) | speed | steel) |
| | | | steel) | |
| | Ejection pressure | 0.5 | 0.5 | 0.5 |
| | (MPa) | | | |
| | Nozzle diameter | 5 | 7 | 5 |
| | (mm) | | | |
| | Ejection time (sec) | 5 | 5 | 5 |

TABLE 10
Side milling cutter (SKH57)

| | | | Comparative |
|---|---|---|---|
| | | Example 16 | Example 9 |
| Surface | Ejection method | LD | LD |
| treatment | Median diameter D₅₀ (μm) of | 20 | 71 |
| | ejection particle | (Zirconia) | (Zirconia) |
| | Ejection pressure (MPa) | 0.01 | 0.05 |
| | Nozzle diameter (mm) | 9 | 9 |
| | Ejection time (sec) | 5 | 5 |

TABLE 11
Hob (SKH57)

| | | | | | Compar- |
|---|---|---|---|---|---|
| | | | | | ative |
| | | Example | Example | Example | Example |
| | | 17 | 18 | 19 | 10 |
| Surface | Ejection method | SF | FD | LD | SF |
| treatment | Median diameter | 13 | 16 | 8 | 80 |
| | D₅₀ (μm) of | (Alloy | (Glass) | (Alumina) | (High- |
| | ejection particle | steel) | | | speed |
| | | | | | steel) |
| | Ejection pressure | 0.3 | 0.5 | 0.05 | 0.3 |
| | (MPa) | | | | |
| | Nozzle diameter | 7 | 5 | 9 | 7 |
| | (mm) | | | | |
| | Ejection time (sec) | 5 | 5 | 5 | 5 |

TABLE 12
Reamer (SKH57)

| | | | Comparative |
|---|---|---|---|
| | | Example 20 | Example 11 |
| Surface | Ejection method | SF | SF |
| treatment | Median diameter D₅₀ (μm) of | 16 | 68 |
| | ejection particle | (Glass) | (Glass) |
| | Ejection pressure (MPa) | 0.5 | 0.5 |
| | Nozzle diameter (mm) | 7 | 7 |
| | Ejection time (sec) | 3 | 3 |

TABLE 13
Metal saw (cemented carbide)

| | | Example | Example | Comparative |
|---|---|---|---|---|
| | | 21 | 22 | Example 12 |
| Surface | Ejection method | SF | LD | LD |
| treatment | Median diameter D₅₀ | 7 | 15 | 46 |
| | (μm) of ejection | (Alloy | (Alumina) | (Zircon) |
| | particle | steel) | | |
| | Ejection pressure | 0.1 | 0.05 | 0.05 |
| | (MPa) | | | |
| | Nozzle diameter (mm) | 7 | 9 | 9 |
| | Ejection time (sec) | 5 | 5 | 5 |

In Tables 2 to 13, the “ejection method” indicates the ejection method for the used blasting apparatus, and indicates the use of the blasting apparatus of the following ejection method.

SF: Suction ejection method (“SFK-2” manufactured by Fuji Manufacturing Co., Ltd.)

FD: Direct pressure ejection method (“FDQ-2” manufactured by Fuji Manufacturing Co., Ltd.)

LD: Gravity ejection method [“LDQ-3” manufactured by Fuji Manufacturing Co., Ltd.]

Polishing with an elastic abrasive was performed by “SIRIUS Processing” (Fuji Manufacturing Co., Ltd.).

The hardness for each material of the ejection particles used is indicated in Table 14 below.

TABLE 14
Material and hardness of ejection particles

| Material | Hardness (Hv) |
|---|---|
| Alloy steel | 870 |
| High-speed steel | 840 |
| Alumina | 1800 |
| Zirconia | 1300 |
| Zircon | 700 |
| Glass | 550 |

### Confirmation of Dimple Formation State

Confirmation by Electron Micrograph

As a result of observation of an electron micrograph of the treatment region after ejecting the ejection particles under the treatment conditions of Examples 1 to 22 explained above, it has been found that the dimples are formed under any treatment condition.

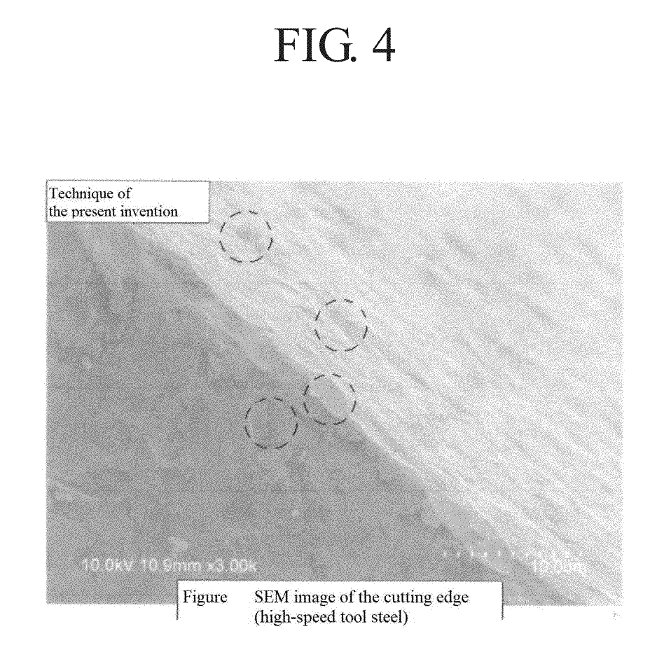

As an example, FIG. 4 shows an electron micrograph of the cutting edge portion of a ball end mill made of high-speed tool steel (SKH51) subjected to surface treatment under the treatment conditions of Example 3.

The dimples which are relatively clearly shown in FIG. 4 are indicated by being enclosed by a broken line circle. As can be seen from FIG. 4, it can be seen that shallow dimples with a relatively small diameter are formed substantially uniformly on both of the ridgelines that are the cutting edge 11 (edge) and opposite inclined surfaces centering on the cutting edge 11.

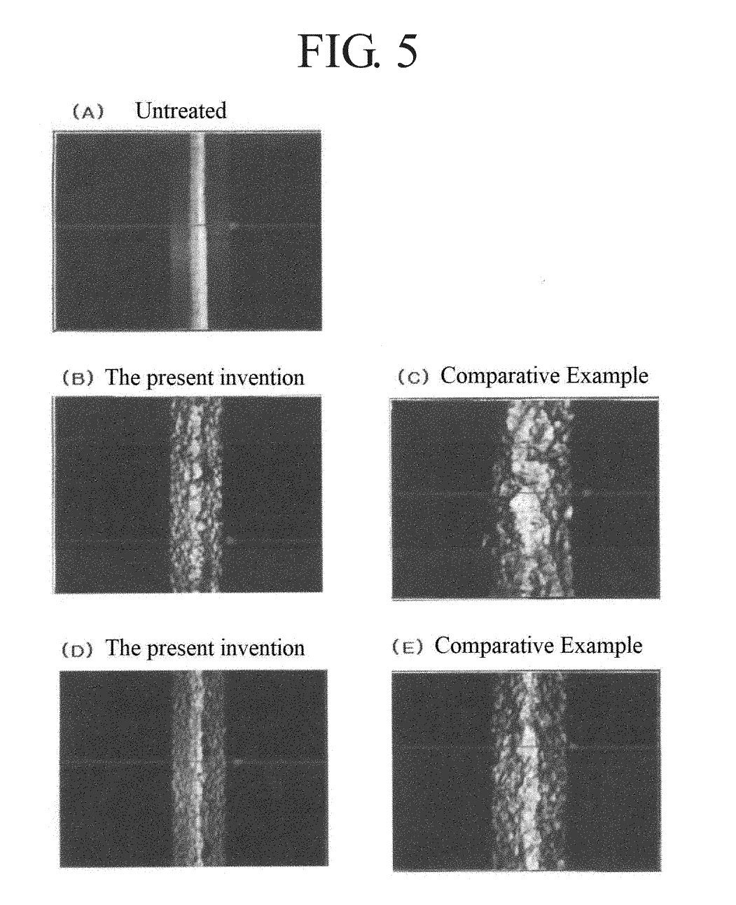

FIG. 5 shows a state photograph of the cutting edge portion of the cutting tool treated by the method of the present invention. In FIG. 5, (A) shows an untreated sample, (B) and (D) show samples treated by the method of the present invention, (C) and (E) show samples treated by the method of Comparative Examples, and (B) to (D) are samples treated by the suction ejection method (SF method). In (B), ejection particles (median diameter of 18 μm) made of alloy steel are ejected for 3 seconds at an ejection pressure of 0.5 MPa, in (C), ejection particles (median diameter of 50 μm) made of high-speed steel are ejected for 3 seconds at an ejection pressure of 0.5 MPa, in (D), ejection particles (median diameter of 18 μm) made of alloy steel are ejected for 3 seconds at an ejection pressure of 0.1 MPa, and in (E), ejection particles (median diameter of 50 μm) made of high-speed steel are ejected for 3 seconds at an ejection pressure of 0.1 MPa.

In the surface treatment method of the present invention, since fine ejection particles with a median diameter of 1 to 20 μm are ejected at an ejection pressure of 0.01 MPa to 0.7 MPa to form dimples, as illustrated in FIG. 5(B) and FIG. 5(D), the dimples can be formed while maintaining the sharpness of the cutting edge without damaging or rounding off the ng edge of the machining tool.

On the other hand, in a machining tool machined by ejecting the ejection particles having a median diameter of 50 μm exceeding the above-mentioned range of particle diameter, as shown in FIG. 5(C) and FIG. 5(E), it has been found that the cutting edge is damaged and becomes blunt.

As described above, in the treatment according to the surface treatment method of the present invention, since the cutting edge does not become blunt and the dimples can be formed while maintaining the sharpness, the surface roughness of the finished surface and the reduction in machining precision accompanying a change in the amount of cut do not occur.

### Measurement of Diameter, Depth, Projected Area of the Dimple

Each of Table 15 (Examples) and Table 16 (Comparative Examples) indicates the result of measurements of the diameter, the depth, and the projected area of the dimple formed on the cutting edge portion of the cutting tool after performing the surface treatment under the treatment conditions of the Examples 1 to 22 and the treatment conditions of Comparative Examples 1 to 12 described above respectively.

The diameter (equivalent diameter) and the depth of the dimple were measured using a shape analysis laser microscope (VK-X250 manufactured by KEYENCE CORPORATION).

In the case where the surface of the cutting edge portion of the cutting tool can be directly measured, the measurement was performed directly, and when the direct measurement cannot be performed, methyl acetate was dropped on the acetylcellulose film to make it conform to the surface of the cutting edge portion of the cutting tool, then dried and peeled off. Then, the measurement was carried out based on dimple which are reversely transferred to an acetylcellulose film.

The measurement was performed using “multi-file analysis application (VK-H1XM, manufactured by KEYENCE CORPORATION)” on the data of the surface image photographed by the shape analysis laser microscope (however, in the measurement using the acetylcellulose film, the image data obtained by reversing the photographed image was used).

Here, the “multi-file analysis application” is an application that can perform, using data measured with a laser microscope, measurements such as surface roughness, line roughness, height and width, analysis of equivalent circle diameter and depth, reference surface setting, and image processing such as height inversion.

In the measurement, the reference surface is set at first by using the “image processing” function (However, when the surface shape is a curved. surface, the reference surface setting is set after correcting the curved surface to a flat surface by using the surface shape correction). Next, the measurement mode is set to recess from the function of “volume area measurement” of the application, and the recess with respect to the set “reference surface” is measured. The average value of the results of the “average depth” and the “equivalent circle diameter” is determined as the depth and the equivalent diameter of the dimple from the measurement result of the recess.

The above-mentioned reference surface was calculated from the height data using the least squares method.

In addition, the aforementioned “equivalent circle diameter” or “equivalent diameter” was measured as the diameter of the circular shape measured by converting the projected area measured as a recess (dimple) into a circular projected area.

The “reference surface” mentioned above refers to the flat surface that is the zero point (reference) of the measurement in the height data, and is mainly used for the measurement in the vertical direction such as depth and height,

TABLE 15
Diameter, depth, and projected area of the dimple (Example)

| | Dimple | |
|---|---|---|
| Treatment | Diameter | Depth |
| conditions | (μm) | (μm) |
| Example 1 | 12.4 | 0.66 |
| Example 2 | 12.6 | 0.61 |
| Example 3 | 8.4 | 0.46 |
| Example 4 | 3.3 | 0.16 |
| Example 5 | 7.5 | 0.21 |
| Example 6 | 13.4 | 0.55 |
| Example 7 | 6.2 | 0.38 |
| Example 8 | 9.1 | 0.09 |
| Example 9 | 3.6 | 0.06 |
| Example 10 | 8.3 | 0.11 |
| Example 11 | 10.5 | 0.19 |
| Example 12 | 14.5 | 0.26 |
| Example 13 | 4.2 | 0.14 |
| Example 14 | 8.8 | 0.72 |
| Example 15 | 16.3 | 0.93 |
| Example 16 | 1.7 | 0.02 |
| Example 17 | 13.4 | 0.59 |
| Example 18 | 15.1 | 0.70 |
| Example 19 | 4.6 | 0.05 |
| Example 20 | 11.3 | 0.56 |
| Example 21 | 5.4 | 0.08 |
| Example 22 | 5.3 | 0.04 |

TABLE 16
Diameter, depth, and projected area of the
dimple (Comparative Example)

| | Dimple | |
|---|---|---|
| Treatment | Diameter | Depth |
| conditions | (μm) | (μm) |
| Comparative | 41.3 | 2.05 |
| Example 1 | | |
| Comparative | 36.7 | 1.68 |
| Example 2 | | |
| Comparative | 21.1 | 1.22 |
| Example 3 | | |
| Comparative | 43.3 | 1.74 |
| Example 4 | | |
| Comparative | 28.5 | 1.41 |
| Example 5 | | |
| Comparative | 22.9 | 1.19 |
| Example 6 | | |
| Comparative | 24.3 | 1.36 |
| Example 7 | | |
| Comparative | 31.2 | 2.61 |
| Example 8 | | |
| Comparative | 27.1 | 1.63 |
| Example 9 | | |
| Comparative | 63.3 | 2.94 |
| Example 0 | | |
| Comparative | 37.7 | 2.32 |
| Example 11 | | |
| Comparative | 19.6 | 1.07 |
| Example 12 | | |

### Cutting Condition

Cutting was performed on pre-hardened steel (HRC 30) using a cutting tool subjected to each of the above-described surface treatments and an untreated cutting tool.

Machining was carried out under the cutting conditions indicated in the following Table 17.

TABLE 17
Cutting conditions

| Cutting Tool Type | Cutting conditions | |
|---|---|---|
| Straight drill | Cutting, speed 15 min | Feeding 0.3 mm/rev |
| Ball end mill | Rotational speed 800 min⁻¹ | Feeding 300 mm/min |
| Bite | Cutting speed 60 m/min | Feeding 0.5 mm |
| Tap | Cutting speed 6 m/min | |
| Broach | Cutting speed 5 m/min | |
| Flat milling cutter | Cutting speed 10 m/min | Feeding 0.03 mm/blade |
| Side milling cutter | Cutting speed 10 m/min | Feeding 0.03 mm/blade |
| Hob | Cutting speed 50 m/min | Feeding 2 mm/rev |
| Reamer | Cutting speed 4 m/min | Feeding 0.5 mm/min |
| Metal saw | Cutting speed 20 m/min | Feeding 0.4 mm/min |

### Evaluation Method and Test Result.

An untreated cutting tool, the cutting tool to which the surface treatment of the present invention is applied (Example) and cutting tools subjected to surface treatment under conditions deviating from the surface treatment conditions of the present invention (Comparative Examples) are used, cuttings are respectively carried out under the above cutting conditions, and the timing when adhesion and chipping of the cutting edge occurs is determined to be a lifespan. The results relating to the durability are indicated in Table 18.

Lifespan in Table 18 indicates how many times the lifespan of the cutting tool of the Examples and the Comparative Examples is increased when the lifespan of the untreated cutting tool is set to “1”.

TABLE 18
Cutting test (durability test) result

| | Treatment | | Tool | Treatment | |
|---|---|---|---|---|---|
| Tool type | conditions | Lifespan | type | conditions | Lifespan |
| Straight | Example 1 | 2.6 | Broach | Example 11 | 1.5 |
| drill | Example 2 | 3.0 | | Example 12 | 1.3 |
| | Comparative | 0.9 | | Example 13 | 1.3 |
| | Example 1 | | | Comparative | 0.9 |
| Ball end | Example 3 | 1.6 | | Example 7 | |
| mill | Example 4 | 1.6 | Flat | Example 14 | 1.4 |
| | Example 5 | 1.8 | milling | Example 15 | 1.8 |
| | Comparative | 1.0 | cutter | Comparative | 0.8 |
| | Example 2 | | | Example 8 | |
| Bite | Example 6 | 1.5 | Side | Example 16 | 1.7 |
| (Cemented | Example 7 | 2.1 | milling | Comparative | 1.0 |
| carbide) | Comparative | 1.2 | cutter | Example 9 | |
| | Example 3 | | Hob | Example 17 | 1.6 |
| Bite | Example 8 | 1.3 | | Example 18 | 1.3 |
| (Alumina) | Comparative | 0.7 | | Example 19 | 1.6 |
| | Example 4 | | | Comparative | 0.9 |
| Bite | Example 9 | 1.6 | | Example 10 | |
| (Cermet) | Comparative | 1.1 | Reamer | Example 20 | 1.4 |
| | Example 5 | | | Comparative | 1.0 |
| Tap | Example 10 | 2.3 | | Example 11 | |
| | Comparative | 1.2 | Metal | Example 21 | 1.5 |
| | Example 6 | | saw | Example 22 | 1.5 |
| | | | | Comparative | 1.0 |
| | | | | Example 12 | |

### Study of Cutting Test Results

As a result of the cutting test, it has been found that each of the cutting tools subjected to the surface treatment of Examples 1 to 22 had a longer lifespan as compared with the untreated cutting tool.

Such longer lifespan can be improved by performing the surface treatment of the present invention. An improvement in the surface hardness of the cutting edge portion of the cutting tool, and an improvement in the lubricity of the rake face because of an oil reservoir formed clue to the formation of dimples on the rake face, can make it possible to suppress heat generation accompanying frictional contact with the swarf, and smoothly discharge the swarf. In addition, as a result of preventing adhesion of the swarf to the rake face, this is thought to enable to improve durability.

As described above, as shown in Table 15, the cutting edge portion of the cutting tool subjected to the surface treatment according to the treatment conditions of Examples 1 to 22 in which the lifespan is improved have relatively small dimples within the range of 1 to 18 μm in equivalent diameter, with a depth of 0.02 to 1.0 μm or less than 1.0 μm and with a projected area of 30% or more. It is understood that formation of dimples within this numerical range is effective in preventing adhesion of cutting tools and the like, and improving durability.

In the Examples for a carbide bite tool, it has been found that further longer lifespan is attained in Example 7 (lifespan of 2.1) and Example 15 (lifespan of 1.8) in which preliminary polishing is performed using an elastic abrasive prior to the formation of dimples by ejecting ejection particles in comparison with Example 6 (lifespan of 1.5) and Example 14 (lifespan of 1.4 which such preliminary polishing is not performed.

From these results, it is though that removing tool marks and the like remaining on the surface of the cutting tool before forming dimples by ejecting the ejection particles, and forming dimples having the uniform height of irregularities contribute to further improvement in lubricity.

Further, in the Example in which the surface treatment of the present invention is applied to a straight drill, it has been found that further longer lifespan is attained even in Example 2 (lifespan of 3.0) in which post-polishing is performed by ejecting an elastic abrasive after forming the dimples by ejecting the ejection particles in comparison with Example 1 (lifespan of 2.6) in which such post-polishing is not performed.

From this result, as described with reference to FIG. 3, this is thought that removing fine protrusions generated at the peripheral edge portion of the dimple at the time of forming the dimple by post-polishing also contributes greatly to the reduction in the contact resistance with the workpiece and the swarf.

In comparison with the untreated products, in the surface treatment conditions of Examples 1 to 22 in which it has been found that each of them had a longer lifespan, it has been found that a slight improvement in the lifespan is attained in Comparative Example 5 (lifespan of 1.1) which is a treated example of bite (cermet) among the cutting tool subjected to the surface treatment of Comparative Examples 1 to 12 in comparison with the untreated product. However, in the other Comparative Examples, the lifespan is shortened as compared with the untreated products.

Here, also in the cutting tool subjected to the surface treatment under the treatment conditions of the Comparative Examples, since the ejection particles are made to collide with the cutting edge portion, it is thought that due to the deformation caused by collision of the ejection particles, the dimple is formed in the cutting edge portion, and hardness in the vicinity of the surface is increased by work hardening accompanying such deformation.

However, in the treatment method of the Comparative Examples, the particle diameter of the ejection powder used for the surface treatment is larger than that of the Examples, and as a result, the formed dimples also exceeded the range in the Examples (see Table 16), i.e., an equivalent diameter of 1 to 18 μm and a depth of 0.02 to 1.0 μm or less than 1.0 μm, thereby generating the same state as when chipping (cutout) occurred at the cutting edge, thus dimple does not function as an oil reservoir. In addition, cutting resistance and heat generation accompanying this resistance increase as a result of rounding off the cutting edge thus reducing machinability, resulting in a shorter lifespan than that of the untreated product.

Therefore, it has been found that in the surface treatment method of the present application, use of an ejection particle having an equivalent diameter of 1 to 18 μm validates the effectiveness of forming dimples having an equivalent diameter of 1 to 18 μm and a depth of 0.02 to 1.0 μm or less than 1.0 μm in the cutting edge portion.

### Test Example 2

### Test for Validating Effects for Blanking Tool Outline of the Test

A blanking tool in which the cutting edge portion is treated by the surface treatment method of the present invention (Example), an untreated blanking tool, and a blanking tool subjected to surface treatment under treatment conditions deviating from the treatment conditions of the present application (Comparative Example) are used for performing a punch pressing, and the state of the cutting edge portion after the blanking press is observed.

### Object to be Treated and Surface Treatment Condition

Surface treatment was carried out under the conditions indicated in the following Table 19 for the cutting edge portion (cutting edge, and the range in 2 mm from the cutting edge) of a punching punch (length of 3 cm, diameter of 0.5 cm) made by SKD11.

TABLE 19
Surface treatment conditions for punching punch

| | | | Comparative |
|---|---|---|---|
| | | Example 23 | Example 13 |
| Surface | Ejection method | SF | SF |
| treatment | Ejection particle median | 15 (High- | 80 (High-speed |
| | diameter D₅₀ (μm) | speed steel) | steel) |
| | Ejection pressure (MPa) | 0.3 | 0.3 |
| | Nozzle diameter (mm) | 7 | 7 |
| | Ejection time (sec) | 5 | 5 |

In the above Table 19, “SF” in the “ejection method” indicates a suction ejection method, and SFK-2 manufactured by Fuji Manufacturing Co., Ltd. was used as a blasting apparatus in the test example.

### Punching Conditions and Observation Method

The punch which had been surface-treated by each of the methods of Example 23 and Comparative Example 13, and an unprocessed punch were used. The punch pressing was carried out 9000 times on steel workpieces (2 mm thick plate material) mad of SS steel. The degree of wear of the surface state of each punch after punch pressing was visually observed and was observed with a microscope.

### Observation Result

The surface state of each punch after punch pressing is shown in the following Table 20.

TABLE 20
Surface state of the punch after punch pressing

| Treatment conditions | Surface state |
|---|---|
| Example 23 | Damage was scarcely observed. |
| Comparative | Many streaky scratches in the longitudinal |
| Example 13 | direction was observed. |
| Untreated | Unavailable at 1800 times. |

### Consideration

The punch subjected to the surface treatment under the treatment conditions of Example 23 has dimples having an equivalent diameter of about 13.2 μm and a depth of about 0.71 μm at the cutting edge portion. It is thought that the dimples thus formed serves as an oil reservoir, and as a result, the sliding property at the time of punching is improved, thereby abrasion of the tool was suppressed.

Formation of dimples is also confirmed on the cutting edge portion of the punch treated under the treatment condition of Comparative Example 13. The formed dimple has an equivalent diameter of 50.2 μm and a depth of 2.81 μm, that is, this dimple is large in comparison with the dimple when the surface treatment is performed under the conditions of Example 23.

As a result, in the example in which the dimple is formed according to the treatment conditions of Comparative Example 13, the shape of the cutting edge is impaired, thus the resistance at the time of punching increased, whereby the cutting edge has worn out early in comparison with the punches subjected to the surface treatment under the conditions of Example 23.

In the example in which the surface treatment (Example 23) of the present invention is carried out, the hardness after the surface treatment increases to about 950 Hv with respect to the untreated surface hardness of about 750 Hv, and it has been found that the hardness increases by about 21%.

In addition, the residual stress after the surface treatment (Example 23 of the present invention is −1200 MPa, whereas the residual stress of the untreated product represents about 200 MPa, that is, “tensile” residual stress, therefore, it has been found hat high “compression” residual stress is imparted, and it is thought that durability is improved by such high compressive residual stress.

Crystal analysis of the surface of the punch after surface treatment (Example 23) of the present invention is carried out by Electron Back Scatter Diffraction Patterns (EBSD) which is one of crystal analysis methods by a scanning electron microscope (SEM). As a result, it has been found that crystal grains on the surface are micronized, and it is thought that such micronization of crystal grains also contributes greatly to improvement in durability.

### Test Example 3

### Test of Cutting of Side Face of End Mill of Aluminum Alloy Outline of the Test

Using a cutting tool in which a cutting edge portion has been subjected to a treatment by the surface treatment method of the present invention, cutting is performed using an aluminum alloy (A5052), which is easy to form a built-up edge, as a workpiece, and adhesion and abrasion state of the workpiece (swarf) to the cutting edge is observed.

### Object to be Treated and Surface Treatment Condition

Surface treatment for the cutting edge portion (cutting edge and range of 5 mm from the cutting edge) of the 4-blade carbide end mill (diameter 10 mm) was carried out under the conditions shown in the following Table 21 (Example 24).

TABLE 21
Surface treatment conditions for planing milling tool

| | | Example 24 |
|---|---|---|
| Surface treatment | Ejection method | SF |
| | Ejection particle median | 8 |
| | diameter D₅₀ (μm) | (alumina) |
| | Ejection pressure (MPa) | 0.3 |
| | Nozzle diameter (mm) | 7 |
| | Ejection time (sec) | 5 |

In above Table 21, “SF” in the “ejection method” indicates a suction ejection method, and SFK-2 manufactured by Fuji Manufacturing Co., Ltd. was used as a blasting apparatus in this test example.

### Cutting Conditions and Observation Method

Cutting was performed on a plate material made of an aluminum alloy (A5052) as a workpiece (object to be cut) using an end mill subjected to surface treatment under the conditions of Example 24 shown in Table 21 and an untreated end mill.

Cutting was carried out with the amount of cut at 0.2 mm and at a cutting speed of 100 m/min, the cutting resistance at this time was measured, and the adhesion state of the swarf to the cutting edge was observed.

The cutting resistance was measured with a three component cutting dynamometer (manufactured by Kistler) and observation of the cutting edge was performed using a microscope (“VHX 600” manufactured by KEYENCE CORPORATION) and an electron microscope (“S6400N” manufactured by Hitachi High-Technologies Corporation).

It should be noted that “cutting resistance” means a force required to continue cutting and is a force composed of a principal cutting force, a feed force, and a thrust force. Here, the principal cutting force and the feed force are measured.

### Measurement and Observation Results

The measurement results of the cutting resistance at the time of planing, and the observation results of the cutting edge by the above method are shown in the following Table 22.

The measurement result of the cutting resistance is shown by the ratio when the cutting resistance of the untreated end mill is set to 1.

TABLE 22
Aluminum planing test result

| | Cutting resistance | Abrasion | Adhesion |
|---|---|---|---|
| Example 24 | 0.8 | None | None |
| Untreated | 1 | Present | Present |

### Consideration

In the end mill (Example 24) subjected to the surface treatment by the method of the present invention, due to the formation of the dimple at the cutting edge and the predetermined range from the cutting edge, the lubricating oil easily spreads to the cutting edge. Therefore, it has been found that even when an aluminum alloy material, which is relatively soft material, thus likely to generate a built-up edge clue to adhesion, is an object to be cut, adhesion (built-up edge) can be prevented.

Further, in the end mill subjected to the surface treatment by the method of the present invention, by the formation of the dimple, an oil film is formed on the cutting edge and the rake face and the flank in the vicinity of the cutting edge, whereby the contact resistance to the surface of the workpiece and the contact resistance with the swarf are reduced, the hardness of the cutting edge increases, and the blunting of the cutting edge due to the formation of the built-up edge, the. increase in the cutting resistance, the increase in the amount of cut, etc. do not occur. As a result, a reduction effect of cutting resistance which is 0.8 times with respect to that of the untreated product can he attained.

### Examples 25 to 27 and Comparative Example 14

### Cutting of Difficult-to-Cut Materials

Next, an Example in which the present invention is applied to a cutting tool for a difficult-to-cut material as a workpiece will be disclosed.

In the treatment of the present invention, a machining tool having dimples formed in the cutting edge and in the vicinity thereof is excellent in reducing adhesion of metals called difficult-to-cut materials such as titanium, stainless steel, heat-resistant alloy generated when machining of such materials is performed.

Here, difficult-to-cut materials are defined as follows:
(1) Materials themselves are difficult cut (material which has properties causing difficult-to-cut properties such as stainless steel, titanium alloy, nickel alloy, iron-nickel alloy, heat-resistant alloy (Inconel, Hastelloy), etc.).
(2) Difficult-to-cut properties are caused by the following material properties:
   a high hardness;
   hard and brittle;
   easy to cause work hardening
   high affinity with a tool material
   a large high temperature strength
   a small thermal conductivity
   containing an abrasive erosion substance
   a high ductility
   difficulty in optimization caused by unknown machinability
(3) Materials with unknown machinability (mainly new materials without cutting data, etc.)
(4) limitable or flammable materials (such as magnesium)

TABLE 23
Cutting conditions

| Cutting tools | Insert chip (cemented carbide + | |
|---|---|---|
| | TiN coating) | |
| Object to be cut | Pure titanium | |
| Cutting speed | 60 | m/min |
| Feeding amount | 0.07 | mm |

| | |
|---|---|
| Lubricant | None |

TABLE 24
Treatment conditions

| | | | | | Comparative |
|---|---|---|---|---|---|
| | | Example 25 | Example 26 | Example 27 | Example 14 |
| Surface | Ejection | SFK-2 | FD-2 | LDQ-3 | SFK-2 |
| treatment | device | (manufactured | (manufactured | (manufactured | (manufactured |
| | | by Fuji | by Fuji | by Fuji | by Fuji |
| | | Manufacturing | Manufacturing | Manufacturing | Manufacturing |
| | | Co., Ltd) | Co., Ltd) | Co., Ltd) | Co., Ltd) |
| | Ejection | SF | FD | LD | SF |
| | method | | | | |
| | Ejection | 16 (alumina) | 4 (zirconia) | 20 (alloy | 80 (high- |
| | particle | | | steel) | speed steel) |
| | median | | | | |
| | diameter | | | | |
| | D50 | | | | |
| | (μm) | | | | |
| | Ejection | 0.5 MPa | 0.2 MPa | 0.05 MPa | 0.3 MPa |
| | pressure | | | | |
| | (MPa) | | | | |
| | Nozzle | 7 | 5 | 9 | 7 |
| | diameter | | | | |
| | (mm) | | | | |
| | Ejection | 3 | 3 | 3 | 3 |
| | time (sec) | | | | |

TABLE 25
Dimple diameter and depth

| Treatment | Dimple | |
|---|---|---|
| conditions | Diameter (μm) | Depth (μm) |
| Example 1 | 14.1 | 0.79 |
| Example 2 | 3.1 | 0.12 |
| Example 3 | 6.4 | 0.17 |
| Comparative Example | 26.5 | 1.51 |

### Evaluation Method

Evaluation is performed by observing presence or absence of the adhesion of the cutting edge after machining one object to be cut.

### Consideration

TABLE 26
Evaluation results

| | Examples 25 to 27 | Comparative Example 14 |
|---|---|---|
| Adhesion | Minute | Large |

TABLE 27
Surface roughness of cutting surface

| | | Comparative |
|---|---|---|
| | Example 25 | Example 14 |
| Surface roughness Ra (μm) | 1.34 | 1.51 |

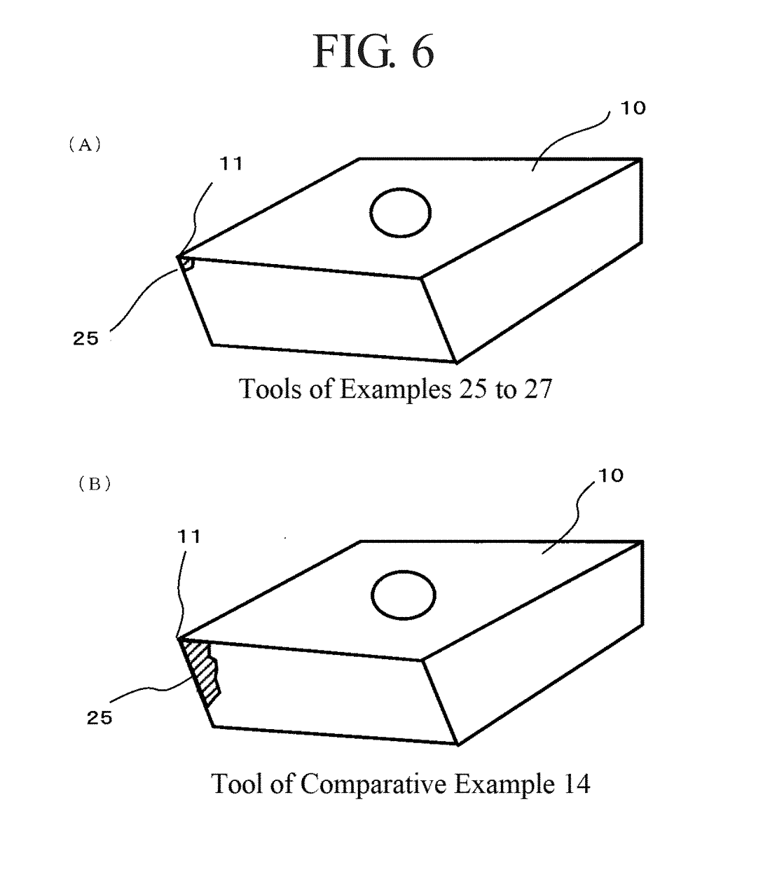

In Examples 25 to 27, almost no adhesion was observed after machining. In Comparative Example 14, apparent adhesion can be observed (see FIG. 6).

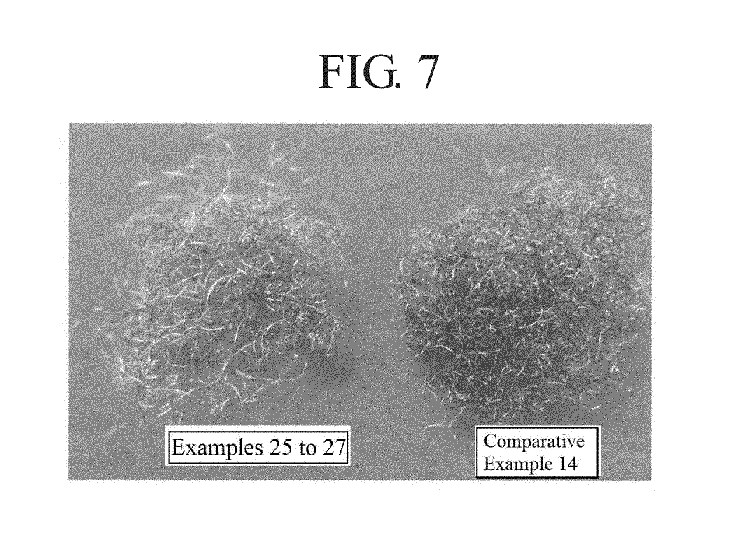

Also, in observing the discharge state of the swarf during cutting, swarfs are entwined in the Comparative Example. However, in Examples 25 to 27, the swarf was smoothly discharged without being entwined (see FIG. 7).

It is thought that dimples formed by the treatment of the present invention reduces the cutting resistance and furthermore the contact resistance between the swarf and the tool at the time of discharging the swarf can be reduced thereby adhesion can be prevented.

### DESCRIPTION OF REFERENCE NUMERALS

10 Cutting tool (machining tool)

11 Cutting edge

12 Rake face

13 Flank

15 Treatment region (or region)

16 Dimple

17 Protrusions

20 Workpiece

21 Swarf

22 Surface

23 Shear surface

24 Finished surface

25 Built-up edge

1. A method for surface treatment of a cutting edge portion of a machining tool, comprising:
setting a treatment region, the treatment region including the cutting edge of the machining tool and an area in a vicinity of the cutting edge;
ejecting substantially spherical ejection particles having a median diameter of 1 to 20 μm to the treatment region at an ejection pressure of 0.01 MPa to 0.7 MPa for forming dimples having an equivalent diameter of 1 to 18 μm and a depth of 0.02 to 1.0 μm or less than 1.0 μm so that a projected area of the dimples occupies 30% or more of a surface area of the treatment region.

2. The method for surface treatment of a cutting edge portion of a machining tool according to claim 1, wherein preliminarily polishing of the treatment region is performed to a surface roughness of Ra of 3.2 μm or less before the ejection of the ejection particles.

3. The method for surface treatment of a cutting edge portion of a machining tool according to claim 2, wherein the preliminary polishing is performed by ejecting elastic abrasives in which abrasive grains are dispersed in each of an elastic body, or the abrasive grains are carried on each of a surface of the elastic body so that the elastic abrasives are slid on the treatment region.

4. The method for surface treatment of a cutting edge portion of a machining tool according to claim 1, wherein the ejection particles are ejected on the treatment region to which a ceramic coating has been applied.

5. The method for surface treatment of a cutting edge portion of a machining tool according to claim 1, wherein a ceramic coating is applied to the treatment region after the ejection of the ejection particles.

6. The method for surface treatment of a cutting edge portion of a machining tool according to claim 1, wherein post polishing is performed to the treatment region for removing minute protrusions generated at a time of formation of the dimples after forming the dimples.

7. The method for surface treatment of a cutting edge portion of a machining tool according to claim 6, wherein the post-polishing is performed by ejecting elastic abrasives in which abrasive grains are dispersed in each of an elastic body, or the abrasive grains are carried on each of a surface of the elastic body so that the elastic abrasives are slid on the treatment region.

8. A structure of a cutting edge portion of a machining tool, the structure comprising dimples having an equivalent diameter of 1 to 18 μm and a depth of 0.02 to 1.0 μm or less than 1.0 μm are formed in a treatment region including a cutting edge and an area in a vicinity of the cutting edge of a machining tool so that a projected area of the dimples occupies 30% or more of a surface area of the treatment region.

9. The method for surface treatment of a cutting edge portion of a machining tool according to claim 2, wherein the ejection particles are ejected on the treatment region to which a ceramic coating has been applied.

10. The method for surface treatment of a cutting edge portion of a machining tool according to claim 3, wherein the ejection particles are ejected on the treatment region to which a ceramic coating has been applied.

11. The method for surface treatment of a cutting edge portion of a machining tool according to claim 2, wherein a ceramic coating is applied to the treatment region after the ejection of the ejection particles.

12. The method for surface treatment of a cutting edge portion of a machining tool according to claim 3, wherein a ceramic coating is applied to the treatment region after the ejection of the ejection particles.

13. The method for surface treatment of a cutting edge portion of a machining tool according to claim 2, wherein post polishing is performed to the treatment region for removing minute protrusions generated at a time of formation of the dimples after forming the dimples.

14. The method for surface treatment of a cutting edge portion of a machining tool according to claim 3, wherein post polishing is performed to the treatment region for removing minute protrusions generated at a time of formation of the dimples after forming the dimples.

15. The method for surface treatment of a cutting edge portion of a machining tool according to claim 4, wherein post polishing is performed to the treatment region for removing minute protrusions generated at a time of formation of the dimples after forming the dimples.

16. The method for surface treatment of a cutting edge portion of a machining tool according to claim 5, wherein post polishing is performed to the treatment region for removing minute protrusions generated at a time of formation of the dimples after forming the dimples.

17. The method for surface treatment of a cutting edge portion of a machining tool according to claim 13, wherein the post-polishing is performed by ejecting elastic abrasives in which abrasive grains are dispersed in each of an elastic body, or the abrasive grains are carried on each of a surface of the elastic body so that the elastic abrasives are slid on the treatment region.

18. The method for surface treatment of a cutting edge portion of a machining tool according to claim 14, wherein the post-polishing is performed by ejecting elastic abrasives in which abrasive grains are dispersed in each of an elastic body, or the abrasive grains are carried on each of a surface of the elastic body so that the elastic abrasives are slid on the treatment region.

19. The method for surface treatment of a cutting edge portion of a machining tool according to claim 15, wherein the post-polishing is performed by ejecting elastic abrasives in which abrasive grains are dispersed in each of an elastic body, or the abrasive grains are carried on each of a surface of the elastic body so that the elastic abrasives are slid on the treatment region.

20. The method for surface treatment of a cutting edge portion of a machining tool according to claim 16, wherein the post-polishing is performed by ejecting elastic abrasives in which abrasive grains are dispersed in each of an elastic body, or the abrasive grains are carried on each of a surface of the elastic body so that the elastic abrasives are slid on the treatment region.
